(19) United States
(12) Patent Application Publication
(10) Pub. No.: US 2003/0136416 A1
(43) Pub. Date: Jul. 24, 2003

(54) Mouthguard adorned with novelty teeth

(75) Inventor: Jesse Jonah White, Hardin, IL (US)

Correspondence Address: Robert G. Lancaster, Esq., BRYAN CAVE LLP, One Metropolitan Square, Suite 3600, 211 North Broadway, St. Louis, MO, 63102, US

(73) Assignee: Billy Bob, Inc.

(21) Appl. No.: 10/055,246

(22) Filed: Jan. 23, 2002

(51) Int. Cl. A61C 5/14

(52) U.S. Cl. 128/859; 128/861

(57) ABSTRACT

A mouthguard adorned with novelty teeth for use by participants in contact activities to protect the teeth. The mouthguard comprises a base portion; an upwardly projecting inner flange portion joined to the base portion; an upwardly projecting outer flange portion joined to the base portion; the upwardly projecting inner flange portion, the upwardly projecting outer flange portion and an upper surface of the base portion forming an upwardly facing U-shaped channel; comprising the outer flange portion and a plurality of three-dimensional tooth representations disposed upon or within the material comprising the outer flange portion.

### BACKGROUND OF THE INVENTION

This invention relates generally to a physical protection device and, more particularly, to a mouthguard for use in protecting against physical injury. Mouthguards are used extensively by participants in athletic activities such as football, hockey, soccer, and field hockey, to prevent bodily injury. Such mouthguards are available in a wide variety of forms and shapes. Mouthguards formed of a variety of materials have been known for many years and are presently in widespread use.

One type is the preformed stock mouthguard, available at most sporting good stores, which comes in predetermined sizes, such as small, medium, and large. Another type of mouthguard is the mouth-formed, also known as “boil and bite,” which is made from thermoplastic material, and can be quickly and easily custom fit to the teeth by the application of moderate heat and pressure. This type of mouthguard is immersed in boiling water and formed in the mouth by using finger, tongue, and biting pressure to receive an impression of the wearer's teeth. When cooled to the normal human body temperature, the mouthguard is resilient and shape retaining.

Yet another type of custom fit mouthguards can also be formed by dental offices or commercial laboratories from a stone cast of the mouth created from an impression fabricated by a dentist. A thermoplastic mouthguard material is then adapted over the stone cast with a vacuum machine and then trimmed and polished.

Prior mouthguards however, have failed to fully overcome a reluctance by many athletic participants to utilize mouthguards for a variety of reasons, including general unattractiveness. Desired increased use of mouthguards can be effected, therefore, by enhancing the aesthetic characteristics.

### SUMMARY OF THE INVENTION

The preferred embodiment of present invention comprises an athletic mouthguard adorned with one of more facsimile teeth, visible in use to other participants and spectators. The array of facsimile teeth may replicate human teeth in a variety of configurations, ranging from aesthetically pleasing to humorously disfigured. The array may additionally or alternatively resemble animal teeth, such as canine fangs, snake fangs or sharks' teeth.

The tooth facsimiles may be shaped and/or colored to resemble dental conditions such as cavities, abscesses or fractures. The facsimile teeth may also be adorned with representations of silver fillings, gold caps, gemstones or orthodontic braces. Additionally, three dimensional forms on or within the outer flange or base material may represent objects secured in the mouth, such as pacifiers, cigarettes or cigars. Due to the novelty appearance and the numerous potential variations in the configurations, use of the mouthguards, particularly among children, is encouraged.

In the preferred embodiment of the present invention a plurality of three-dimensional tooth representations disposed within or upon the foundation material are preferably disposed on pink or other appropriately colored outer flange or base material configured to resemble gum tissue. The outer flange or base material may additionally be shaped and/or colored to resemble disfigurements or disorders of the gums, such as gingivitis. The outer flange or base material may also be shaped and/or colored to resemble portions of the interior of a human or animal mouth, such as a representation of a tongue.

The invention is a molded mouthguard including a U-shaped base portion; an upwardly projecting inner flange portion joined to the base portion; an upwardly projecting outer flange portion joined to the base portion; the upwardly projecting inner flange portion, the upwardly projecting outer flange portion and an upper surface of the base portion forming an upwardly facing U-shaped channel, and a plurality of three-dimensional tooth representations disposed within or upon the outer flange or base portion material.

The outer flange or base portion of the mouthguard may comprise a light pervious foundation material, and a plurality of three-dimensional tooth representations disposed within or upon the foundation material. The novelty appearance created by the array of three-dimensional tooth representations enhances the aesthetic characteristics of the mouthguard, thereby encouraging its use.

According to one feature of the invention, the mouthguard material can be preformed into shapes and sizes designed to accommodate a human mouth. According to another feature of the invention, the mouthguard material may be heated to a malleable state to facilitate fitting of the mouthguard to a particular user.

According to yet another feature of the invention, the mouthguard further includes a downwardly projecting inner flange portion joined to the base portion, and a downwardly projecting outer flange portion joined to the base portion; the downwardly projecting inner flange portion, the downwardly projecting outer flange portion and a lower surface of the base portion forming a downwardly facing U-shaped channel and, and a plurality of three-dimensional tooth representations disposed within or upon the outer flange or base portion material. The downwardly facing channel accommodates a user's lower teeth.

### BRIEF DESCRIPTION OF THE DRAWINGS

These and other objects and features of the invention will become more apparent upon a perusal of the following description taken in conjunction with the accompanying drawings wherein:

FIG. 1 is a perspective view of one embodiment of the invention;

FIG. 2 is a perspective view of another embodiment of the invention;

FIG. 3 is a perspective view of another embodiment of the invention;

FIG. 4 is a perspective view of another embodiment of the invention;

FIG. 5 is a perspective view of another embodiment of the invention;

### DESCRIPTION OF THE PREFERRED EMBODIMENTS

The preferred embodiment of present invention comprises an athletic mouthguard which displays an array of facsimile teeth, on its outer surface visible to other participants and spectators. The array may replicate human teeth in a variety of configurations, ranging from aesthetically pleasing to humorously disfigured. The mouthguard may be shaped and/or colored to resemble human gum tissue. The mouthguard and/or the array of facsimile teeth may be shaped and/or colored to resemble dental disorders such as cavities, abscesses or other dental conditions.

The array may additionally or alternatively resemble animal teeth, such as canine fangs or sharks' teeth. The teeth may also be adorned with gold teeth, gemstones or braces, pacifier, cigarettes or cigars. In the preferred embodiment of the present invention facsimile teeth are preferably disposed in material resembling gum tissue. This material may be shaped and/or colored to resemble gum disorders, such as gingivitis or to resemble the interior portion of a human or other animal mouth, including tongue.

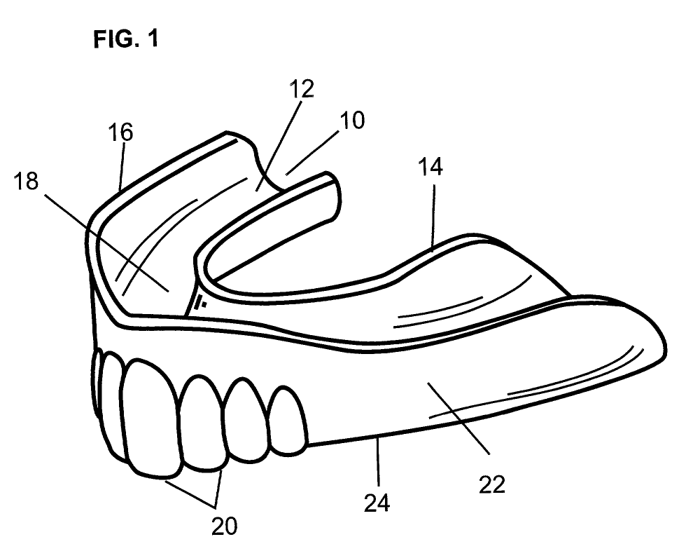

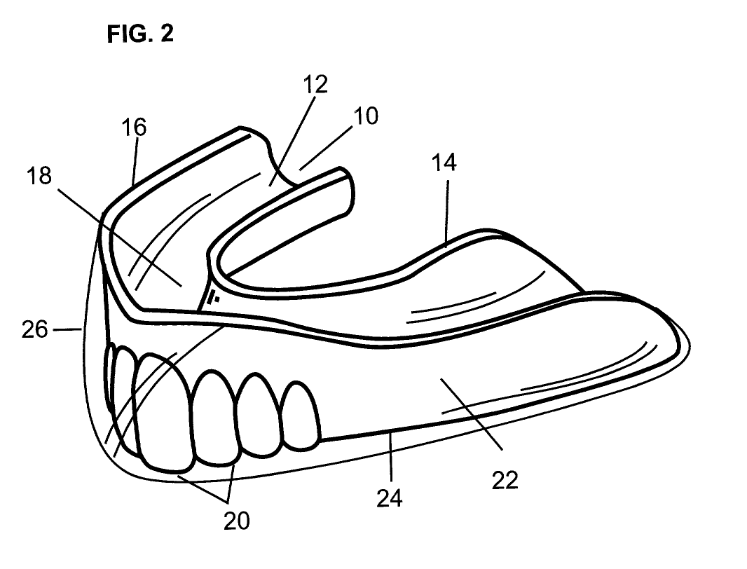

As shown in FIG. 1, the mouthguard 10 is shaped and dimensioned for retention in the mouth of a user engaged in an athletic endeavor. Included in the mouthguard 10 is a U-shaped base portion 12 and inner and outer portions 14 and 16 projecting therefrom. The mouthguard is shaped and arranged to receive the upper or lower teeth of a user as described hereinafter.

Forming the mouthguard 10 are an upwardly projecting inner flange portion 14 joined to the base portion 12 and an upwardly projecting outer flange portion 16 joined to the base portion 12. The upwardly projecting inner and outer flange portions 14 and 16 extend transversely from an upper surface 18 of the base portion 12. Together, the upper surface of the base portion 12 and upwardly projecting inner and outer flange portions 14 and 16 form an upwardly facing U-shaped channel shaped and arranged to receive the upper teeth of a user. A plurality of facsimile teeth 20 are disposed on the outer surface 22 of the outer flange portion and the outer surface 24 of the base portion 12.

The mouthguard 10 is used in the conventional manner to reduce the risk of physical injury to a user engaged in an athletic activity. During such use, the mouthguard 10 is positioned in the user's mouth with upper and lower teeth (not shown), received, respectively, by the upwardly and downwardly facing U-shaped channels. The arrangement of the plurality of facsimile teeth 20 provides an attractive and interesting appearance which inspires use of the mouthguard 10 and thereby reduces the occurrence of various types of head and mouth injuries. Further interest in use can be stimulated by configuring the teeth to correspond to those of the mascot or other symbol of a team with which a user is participating.

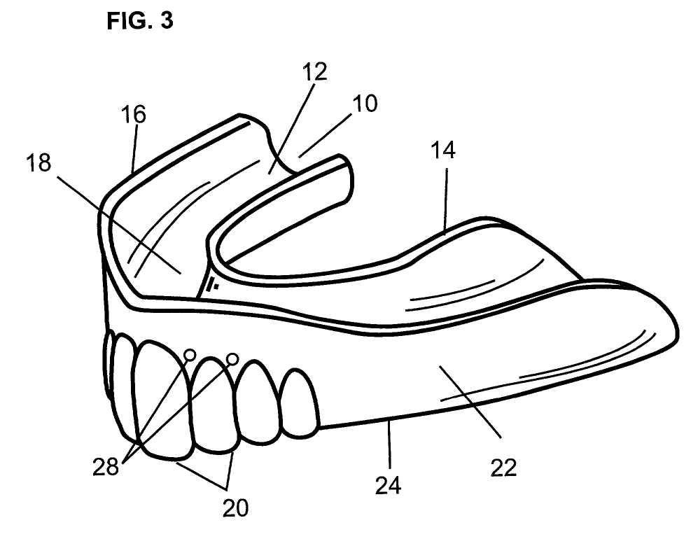

Another preferred embodiment of the mouthguard 10 is illustrated in FIG. 2 and made by providing a layer of light pervious material 26, such as transparent or translucent thermoplastic, over the facsimile teeth 20 disposed on the outer surface of the outer flange portions and the base portion 12. Preferably, the thermoplastic material is a type which can be heated to a malleable state to facilitate fitting of the mouthguard 10 to a particular user.

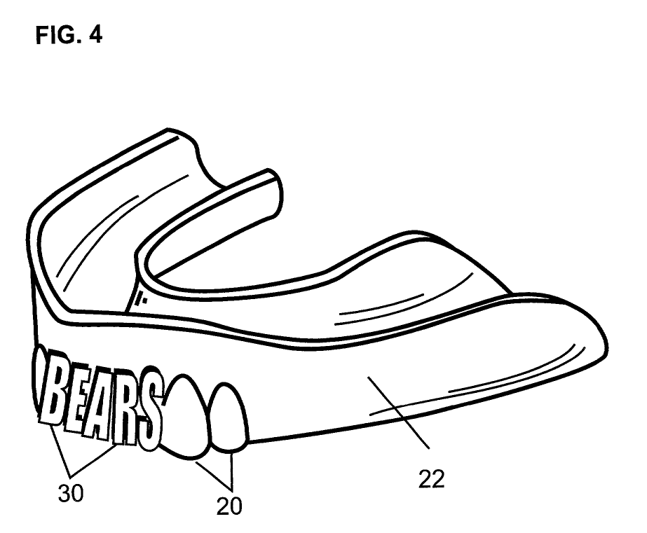

Another preferred embodiment of the present invention is illustrated in FIG. 3 and comprises a mouthguard with one or more light sources 28 disposed on or within the outer surface 22 of the outer flange portion and the outer surface 24 of the base portion 12. Such light sources may include LED's, laser LED's, miniature incandescent light bulbs and chemical light sources. Such light sources may emit light in a continuous, flashing, random or sequenced pattern. The power supplies for the light sources 28 may be located entirely or partially within the mouthguard material or may be remotely located. The light sources 28 may be used in conjunction with the plurality of facsimile teeth 20 disposed on the outer surface 22 of the outer flange portion and the outer surface 24 of the base portion 12.

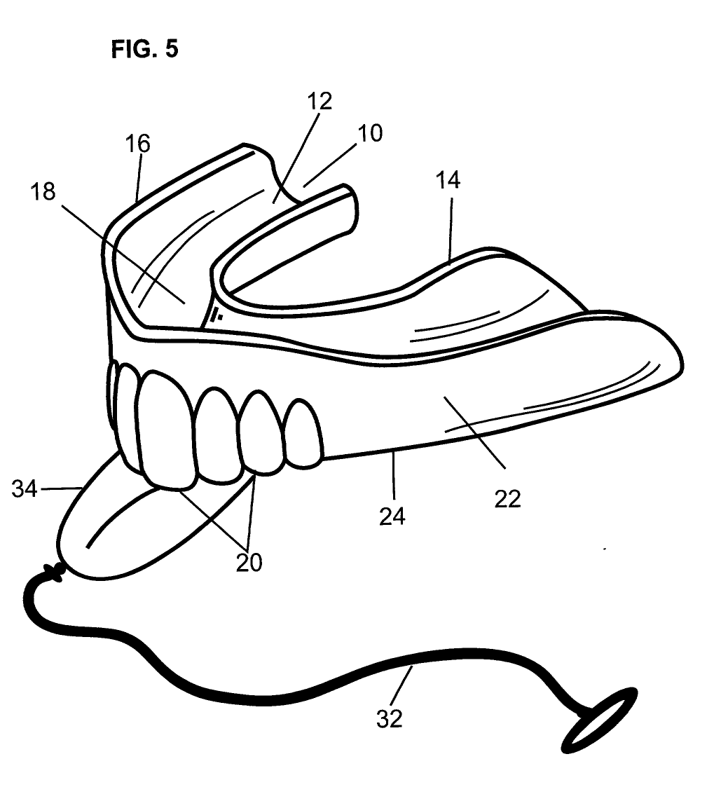

Another preferred embodiment of the present invention is illustrated in FIG. 4 and comprises a mouthguard with one or more three-dimensional alphabetic letters 30 disposed on or within on the outer surface 22 of the outer flange portion. Such letters can be configured to correspond to those of the name of the team or the user. The three-dimensional alphabetic letters 30 may be used in conjunction with the plurality of facsimile teeth 20 disposed on the outer surface 22 of the outer flange portion and the outer surface 24 of the base portion 12.

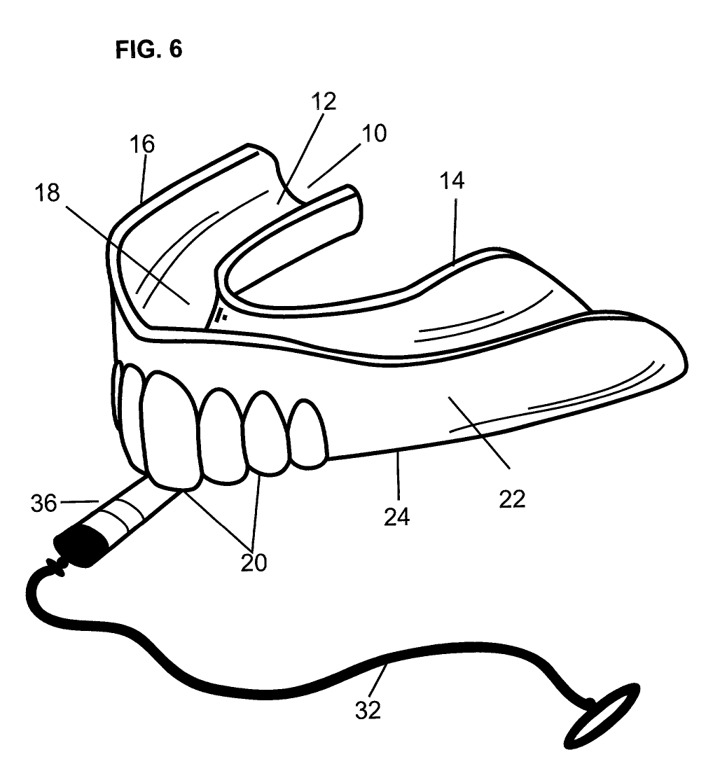

Obviously, many modifications and variations of the present invention are possible in light of the above teachings. For example, the mouthguard 10 can be provided with a conventional strap for attachment to a user's helmet or the like. Alternatively, as illustrated in FIG. 5 and FIG. 6, the mouthguard 10 may be formed or fitted with an integral keeper strap 32, which may be connected to the mouthguard by a protrusion resembling a tongue 34, as illustrated in FIG. 5, or a protrusion resembling a cigarette 36, as illustrated in FIG. 6, or any other item known to protrude from a user's mouth.

What is claimed is:

1. A mouthguard comprising a U-shaped base portion; an upwardly projecting inner flange portion joined to said base portion; an upwardly projecting outer flange portion joined to said base portion; said upwardly projecting inner flange portion, said upwardly projecting outer flange portion and an upper surface of said base portion forming an upwardly facing U-shaped channel, and at least one three-dimensional representation of a tooth disposed on the outer surface of the outer flange.

2. A mouthguard according to claim 1 further comprising a layer of light pervious material disposed on the outer surface of the outer flange.

3. A mouthguard according to claim 2 wherein said layer of light pervious material is comprised of transparent thermoplastic.

4. A mouthguard according to claim 2 wherein said layer of light pervious material is comprised of translucent thermoplastic.

5. A mouthguard according to claim 2 wherein said layer of light pervious material is disposed over at least one three-dimensional representation of a tooth.

6. A mouthguard according to claim 1 wherein said base portion material is a thermoplastic.

7. A mouthguard according to claim 1 wherein said foundation material can be heated to a malleable state to facilitate fitting of said mouthguard to a particular user.

8. A mouthguard comprising a U-shaped base portion; an upwardly projecting inner flange portion joined to said base portion; an upwardly projecting outer flange portion joined to said base portion; said upwardly projecting inner flange portion, said upwardly projecting outer flange portion and an upper surface of said base portion forming an upwardly facing U-shaped channel, and at least one light source disposed on the outer surface of the outer flange.

9. A mouthguard comprising a base portion; an upwardly projecting inner flange portion joined to said base portion; an upwardly projecting outer flange portion joined to said base portion; said upwardly projecting inner flange portion, said upwardly projecting outer flange portion and an upper surface of said base portion forming an upwardly facing U-shaped channel, and at least one three-dimensional representation of an alphabetic letter disposed on the outer surface of the outer flange.

10. A mouthguard according to claim 9 further comprising a team logo disposed on the outer surface of the outer flange.
